(19) United States
(12) Patent Application Publication
(10) Pub. No.: US 2025/0328977 A1
(43) Pub. Date: Oct. 23, 2025

(54) ALLOCATION-OF-VEHICLE ASSISTING METHOD, ALLOCATION-OF-VEHICLE ASSISTING APPARATUS, TERMINAL APPARATUS, AND ALLOCATION-OF-VEHICLE ASSISTING SYSTEM

(71) Applicant: Panasonic Intellectual Property Management Co., Ltd., Osaka (JP)

(72) Inventors: Akhilesh BALAYAN, Gurugram (IN); Tomoyuki IWAKUMA, Chiba-ken (JP)

(73) Assignee: Panasonic Intellectual Property Management Co., Ltd., Osaka (JP)

(21) Appl. No.: 19/055,752

(22) Filed: Feb. 18, 2025

(30) Foreign Application Priority Data
Apr. 22, 2024 (JP) 2024-069076

(51) Int. Cl. G06Q 50/40; G06Q 10/02

(52) U.S. Cl. CPC G06Q 50/40; G06Q 10/02

(57) ABSTRACT

An allocation-of-vehicle assisting method according to the present disclosure is performed by an allocation-of-vehicle assisting apparatus for allocating a vehicle to a user. The allocation-of-vehicle assisting method includes: identifying destination information indicating a destination of the user based on current-position information indicating a current position of the user and history information indicating a history of previous usage of the vehicle by the user; identifying, using the destination information, candidate riding-position information indicating a candidate position where the user rides the vehicle; and outputting output information including the destination information, the candidate riding-position information, and booking information for booking an allocation of the vehicle driving from the candidate position to the destination.

### CROSS-REFERENCE TO RELATED APPLICATIONS

This application is based upon and claims the benefit of priority from Japanese Patent Application No. 2024-069076, filed on Apr. 22, 2024, the entire contents of which are incorporated herein by reference.

### FIELD

The present disclosure relates to an allocation-of-vehicle assisting method, an allocation-of-vehicle assisting apparatus, a terminal apparatus, and an allocation-of-vehicle assisting system.

### BACKGROUND

It is more and more encouraged to use public transportations to reduce environmental loads caused by emission of carbon dioxide, etc. For example, utilization of public transportations is encouraged on an assumption that the public transportations emit less amounts of carbon dioxide than private vehicles or the like. More particularly, users are encouraged to use a public transportation(s) between their start position and their goal position, if any.

Some users may travel long from a start position to a position where he/she rides a public transportation or from a position where he/she gets down a public transportation to a goal position, and they may use ride-hailing services, such as rideshare. For example, a user may use ride-hailing services by, for his/her daily commuting, inputting a destination position, checking a usage fee to the destination position, and then booking an allocation of a vehicle.

A related technique is described in JP 2021-002111 A.

Nevertheless, for his/her daily commuting, a user needs to input a destination position, check a usage fee to the destination position, and book an allocation of a vehicle each time he/her uses a ride-hailing service, which sometimes places a burden on the user, and there is room for further improvement.

The present disclosure has been devised in view of the above-described issues, and provides an allocation-of-vehicle assisting method, an allocation-of-vehicle assisting apparatus, a terminal apparatus, and an allocation-of-vehicle assisting system that can improve the convenience of users as compared with the prior art, when a ride-hailing service is used.

### SUMMARY

An allocation-of-vehicle assisting method according to the present disclosure is performed by an allocation-of-vehicle assisting apparatus for allocating a vehicle to a user. The allocation-of-vehicle assisting method includes: identifying destination information indicating a destination of the user based on current-position information indicating a current position of the user and history information indicating a history of previous usage of the vehicle by the user; identifying, using the destination information, candidate riding-position information indicating a candidate position where the user rides the vehicle; and outputting output information including the destination information, the candidate riding-position information, and booking information for booking an allocation of the vehicle driving from the candidate position to the destination.

### BRIEF DESCRIPTION OF THE DRAWINGS

FIG. 1 is a block diagram illustrating an example of a schematic configuration of an allocation-of-vehicle assisting system according to an embodiment;

FIG. 2 is a schematic diagram illustrating an example of output information according to an embodiment;

FIG. 3 is a sequence diagram illustrating an example of a flow of processing of an allocation-of-vehicle assisting system according to an embodiment; and

FIG. 4 is a block diagram illustrating an example of a hardware configuration of an allocation-of-vehicle assisting apparatus according to an embodiment.

### DETAILED DESCRIPTION

Hereinafter, an allocation-of-vehicle assisting method, an allocation-of-vehicle assisting apparatus, a terminal apparatus, and an allocation-of-vehicle assisting system according to an embodiment of the present disclosure will be described in detail with reference to the drawings.

### Embodiment

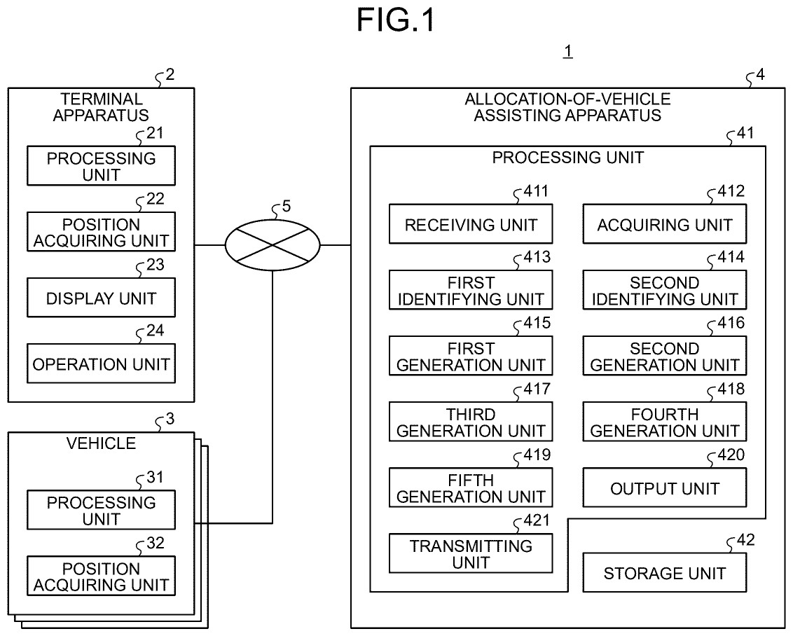

FIG. 1 is a diagram illustrating an example of a schematic configuration of an allocation-of-vehicle assisting system 1 according to an embodiment. The allocation-of-vehicle assisting system 1 of the present embodiment is applied to, for example, a share-riding (rideshare) service provided by a taxi business operator that manages the allocation of two or more movable bodies (taxies). In such a share-riding (rideshare) service, two or more users (two or more users or two or more groups of users) can use one movable body (taxi), and each of the two or more users can designate a position where he/her gets down the movable body (taxi). Further, the share-riding (rideshare) service may be made usable by one user.

Further, two or more users may ride a movable body at different locations, and a position where each of the two or more users rides a movable body can also be designated. Accordingly, a path of a movable body is not determined, and a planned route of the movable body is changed to an optimum route in accordance with a position where a user who uses a movable body rides the movable body, a position where the user gets down the movable body, and the like. In addition, movable bodies are not limited to automobiles for business use of which the allocation is managed by a transportation business operator such as a taxi business operator, and may be private vehicles of users who have registered their vehicles in a business operator that provides a share-riding service. Further, movable body are not limited to automobiles, and may be two-wheel vehicles, three-wheel vehicles, or the like.

As illustrated in FIG. 1, the allocation-of-vehicle assisting system 1 includes a terminal apparatus 2, two or more (three in the example in FIG. 1) vehicles 3, and an allocation-of-vehicle assisting apparatus 4. FIG. 1 exemplifies the three vehicles 3, but the number of vehicles 3 is not limited to this, and the number of vehicles 3 included in the allocation-of-vehicle assisting system 1 can be arbitrarily changed in accordance with a design condition or the like. In the example in FIG. 1, the terminal apparatus 2, the vehicles 3, and the allocation-of-vehicle assisting apparatus 4 can connect to each other via a network 5 such as the internet, for example.

The terminal apparatus 2 is an apparatus to be used by a user. The terminal apparatus 2 is a mobile terminal that can be carried by a user, and is a smartphone, for example. In addition, the mobile terminal is not limited to the smartphone. The mobile terminal may be a tablet-type mobile information terminal having a communication function, or the like. A user uses an allocation-of-vehicle assisting service provided by the allocation-of-vehicle assisting apparatus 4, via the terminal apparatus 2. The terminal apparatus 2 includes a processing unit 21, a position acquiring unit 22, a display unit 23, and an operation unit 24.

The processing unit 21 is formed by a microcomputer including a processor and a memory, for example. That is, the processing unit 21 is implemented by a computer system including a processor and a memory. Then, by the processor executing a predetermined program, the computer system functions as the processing unit 21. The program may be preliminarily recorded in a memory, or may be provided via a telecommunication line such as the internet, or with being recorded in a non-transitory recording medium such as a memory card.

Using a positioning system such as a Global Positioning System (GPS), for example, the position acquiring unit 22 acquires current-position information indicating a current position of the terminal apparatus 2 (i.e., a current position of a user who carries the terminal apparatus 2). The processing unit 21 transmits the current-position information acquired by the position acquiring unit 22, to the terminal apparatus 2.

The display unit 23 is formed by, for example, a liquid crystal display, an organic electro luminescence (EL) display, or the like. The display unit 23 displays output information transmitted from the allocation-of-vehicle assisting apparatus 4, for example, as characters, figures, symbols, or the like.

The operation unit 24 includes, for example, a touch panel provided on the display unit 23, an operation button provided on the main body of the terminal apparatus 2, and the like, and receives operations performed by the user.

The vehicles 3 are movable bodies that users ride. Further, the vehicles 3 are movable bodies of which travelling is managed by the allocation-of-vehicle assisting apparatus 4. The vehicles 3 each includes a processing unit 31 and a position acquiring unit 32.

The processing unit 31 is formed by a microcomputer including a processor and a memory, for example. That is, the processing unit 31 is implemented by a computer system including a processor and a memory. Then, by the processor executing a predetermined program, the computer system functions as the processing unit 31. The program may be preliminarily recorded in a memory, or may be provided via a telecommunication line such as the internet, or with being recorded in a non-transitory recording medium such as a memory card.

Using a positioning system such as the GPS, for example, the position acquiring unit 32 acquires position information indicating a current position of the vehicle 3. The position acquiring unit 32 outputs the acquired position information indicating the current position of the vehicle 3, to the processing unit 31. Then, the processing unit 31 transmits the output position information indicating the current position of the vehicle 3, to the allocation-of-vehicle assisting apparatus 4.

The allocation-of-vehicle assisting apparatus 4 is an apparatus that provides users with the allocation-of-vehicle assisting service. For example, the allocation-of-vehicle assisting apparatus 4 is an apparatus that manages the allocation of the vehicles 3, and assists users in allocating the vehicles 3. The allocation-of-vehicle assisting apparatus 4 includes a processing unit 41 and a storage unit 42.

The processing unit 41 is formed by a microcomputer including a processor and a memory, for example. That is, the processing unit 41 is implemented by a computer system including a processor and a memory. Then, by the processor executing a predetermined program, the computer system functions as the processing unit 41. The program may be preliminarily recorded in a memory, or may be provided via a telecommunication line such as the internet, or with being recorded in a non-transitory recording medium such as a memory card.

The storage unit 42 includes an external storage device such as, for example, a hard disk drive (HDD) or a solid state drive (SSD). In the storage unit 42, contact information (for example, an identifier, a phone number, an e-mail address, or the like of a user) of the terminal apparatus 2 carried by the user of a ride-hailing service is registered. In the storage unit 42, contact information (for example, contact or the like of drivers who drive the vehicles 3) of two or more vehicles 3 of which travelling is managed is registered. In the storage unit 42, map information of an area where the ride-hailing service is provided, or the like is registered. In the storage unit 42, history information indicating a history of previous usage of the vehicle by the user is registered.

Further, the storage unit 42 stores current-position information and booking instruction information transmitted from the terminal apparatus 2. Moreover, the storage unit 42 stores destination information and candidate riding-position information that are identified by the processing unit 41, and route information, fee information, reduction effect information, booking information, and output information that are generated by the processing unit 41. Then, the storage unit 42 stores allocation-of-vehicle information transmitted by the processing unit 41. The details of the current-position information, the booking instruction information, the destination information, the candidate riding-position information, the route information, the fee information, the reduction effect information, the booking information, the output information, and the allocation-of-vehicle information to be stored in the storage unit 42 will be described later.

The processing unit 41 includes a receiving unit 411, an acquiring unit 412, a first identifying unit 413, a second identifying unit 414, a first generation unit 415, a second generation unit 416, a third generation unit 417, a fourth generation unit 418, a fifth generation unit 419, an output unit 420, and a transmitting unit 421.

The receiving unit 411 receives current-position information indicating a current position of a user. Specifically, the receiving unit 411 receives current-position information indicating a current position of a user that is transmitted by the terminal apparatus 2. The current-position information includes latitude-longitude information indicating a current position of a user, identifier information indicating an identifier for identifying a user, time information indicating a time at which current-position information is transmitted, and the like. The receiving unit 411 chronologically receives current-position information. The receiving unit 411 stores chronologically-received current-position information into the storage unit 42.

The acquiring unit 412 acquires history information indicating a history of previous usage of the vehicles 3 by a user. Specifically, the acquiring unit 412 identifies a user based on the identifier information included in the current-position information received by the receiving unit 411, and acquires history information indicating a history of previous usage of the vehicle 3 by the identified user, from the storage unit 42. The history information includes identifier information indicating an identifier for identifying a user, usage-date-and-time information indicating usage date and time on which a user has used the ride-hailing service, riding-position information indicating a riding position where the user has used the ride-hailing service, get-down position information indicating a get-down position where the user has used the ride-hailing service, fee information indicating a fee for the user using the ride-hailing service, travelling route information indicating a route for the user travelling from a riding position to a get-down position, and the like.

The first identifying unit 413 identifies destination information indicating a destination of the user, based on the current-position information and the history information. Specifically, the first identifying unit 413 identifies destination information indicating a destination of the user, based on the current-position information of the user that has been received by the receiving unit 411, and the history information acquired by the acquiring unit 412. The destination of the user includes a position of a public transportation that the user uses and a final goal position where a travel by the user ends. The position of the public transportation is, for example, a position of a train station, a bus stop, or the like. The destination information includes latitude-longitude information indicating a position of a destination of a user, and identified-date-and-time information indicating date and time on which the destination of the user has been identified, and the like.

Here, the destination of a user will be described in detail. When a user uses a public transportation and an allocation-of-vehicle assisting service as means of transportation for travelling from a current position to a final goal position, a riding position in using the allocation-of-vehicle assisting service varies depending on the current position of the user.

For example, it is considered that the user has already passed through a position where the user stayed a predetermined time before from a current time, in travelling of the user. Accordingly, the first identifying unit 413 excludes, from the destination, a current position of the user that is included in the current-position information acquired by the receiving unit 411, where the user stayed a predetermined time before from a current time. In addition, the predetermined time may be preliminarily set.

For example, when the current position of the user overlaps with the position of the public transportation, it is assumed that the user travels from the public transportation as a start position. Accordingly, when a current position of the user that is included in the current-position information acquired by the receiving unit 411 overlaps with the position of the public transportation, the first identifying unit 413 identifies the final goal position as the destination.

For example, when the current position of the user does not overlap with the position of the public transportation, it is assumed that the user travels to the public transportation as a reach position. Accordingly, when a current position of the user that is included in the current-position information acquired by the receiving unit 411 does not overlap with the position of the public transportation, the first identifying unit 413 identifies the position of the public transportation as the destination. The first identifying unit 413 stores the identified destination information into the storage unit 42.

The second identifying unit 414 identifies candidate riding-position information indicating a candidate position where the user rides the vehicle, using the destination information. Specifically, the second identifying unit 414 identifies candidate riding-position information indicating a candidate position where the user rides the vehicle, using latitude-longitude information indicating a position of a destination of the user that is included in the destination information identified by the first identifying unit 413. Hereinafter, a candidate of a position where the user rides the vehicle will also be referred to as a candidate riding position.

For example, when the first identifying unit 413 identifies the final goal position as the destination, the second identifying unit 414 identifies candidate riding-position information indicating a candidate position where the user rides the vehicle, using latitude-longitude information indicating a position of the final goal position that is included in the destination information. Further, for example, when the first identifying unit 413 identifies the position of the public transportation as the destination, the second identifying unit 414 identifies candidate riding-position information indicating a candidate position where the user rides the vehicle, using latitude-longitude information indicating the position of the public transportation that is included in the destination information. The second identifying unit 414 stores the identified candidate riding-position information into the storage unit 42.

The first generation unit 415 generates route information indicating a route from a candidate riding position to a destination, using the candidate riding-position information and the destination information. Specifically, the first generation unit 415 generates route information indicating a route from a candidate riding position to a destination, using a latitude and a longitude of a candidate position where the user rides the vehicle that is included in the candidate riding-position information identified by the second identifying unit 414, and a latitude and a longitude of a destination of the user that is included in the destination information identified by the first identifying unit 413. The route information includes a distance information indicating a distance of a route from a candidate riding position to a destination, travelling time information indicating a time required for travelling from the candidate riding position to the destination, and the like. The first generation unit 415 stores the generated route information into the storage unit 42.

The second generation unit 416 generates fee information about usage of the vehicle 3 based on the route information. Specifically, the second generation unit 416 generates fee information about usage of the vehicle 3 based on the route information generated by the first generation unit 415. The fee information includes first usage-fee information indicating a usage fee for the user riding alone and second usage-fee information indicating a usage fee for the user riding-share. The second generation unit 416 stores the generated fee information into the storage unit 42.

The third generation unit 417 generates reduction effect information that indicates an effect of reduction of carbon dioxide. Specifically, the third generation unit 417 generates reduction effect information that indicates, by comparing in travelling from the current position to the final goal position a first means of transportation that uses a user's vehicle only to a second means of transportation that uses the vehicle 3 and the public transportation, an effect of reduction of carbon dioxide that leads to decarbonization when the second means of transportation is selected as compared to the first means of transportation.

For example, the third generation unit 417 generates route information indicating a route from the current position to the final goal position that corresponds to the first means of transportation that uses a user's vehicle only, using a latitude and a longitude of a current position, and a latitude and a longitude of the final goal position identified by the first identifying unit 413, in travelling from the current position to the final goal position. Further, the third generation unit 417 generates first emission-amount information indicating an emission amount of carbon dioxide, using a travelling time and a travelling distance that are included in the generated route information indicating a route from the current position to the final goal position.

Moreover, the third generation unit 417 generates second emission-amount information indicating an emission amount of carbon dioxide, using a travelling time and a travelling distance that are included in the route information indicating a route from the current position to the final goal position that has been generated by the second generation unit 416. Then, the third generation unit 417 generates difference information by calculating a difference between the emission amount included in the first emission-amount information, and the emission amount included in the second emission-amount information. The difference information generated by the third generation unit 417 corresponds to the above-described reduction effect information. The third generation unit 417 stores the generated reduction effect information into the storage unit 42.

The fourth generation unit 418 generates booking information for booking an allocation of the vehicle 3 driving from the candidate riding position to the destination. Specifically, the fourth generation unit 418 generates booking information for booking an allocation of the vehicle 3 driving from the candidate riding position to the destination, using a latitude and a longitude of a candidate position where the user rides the vehicle that is included in the candidate riding-position information identified by the second identifying unit 414, and a latitude and a longitude of a destination of the user that is included in the destination information identified by the first identifying unit 413. For example, the fourth generation unit 418 generates booking information for booking an allocation of the vehicle 3, as a vehicle for driving along the route information generated by the first generation unit 415. The fourth generation unit 418 stores the generated booking information into the storage unit 42.

The fifth generation unit 419 generates output information including the destination information, the candidate riding-position information, and the booking information. Specifically, the fifth generation unit 419 generates output information including the destination information identified by the first identifying unit 413, the candidate riding-position information identified by the second identifying unit 414, and the booking information for booking an allocation of the vehicle 3 driving from the candidate riding position to the destination that has been generated by the fourth generation unit 418. The output information may include the current-position information received by the receiving unit 411. Further, the output information may include the route information generated by the first generation unit 415. Moreover, the output information may include the fee information generated by the second generation unit 416. Then, the output information may include the reduction effect information generated by the third generation unit 417. The fifth generation unit 419 stores the generated output information into the storage unit 42.

The output unit 420 outputs the output information. Specifically, the output unit 420 outputs the output information generated by the fifth generation unit 419. For example, the output unit 420 outputs the output information generated by the fifth generation unit 419, to the terminal apparatus 2.

Then, the processing unit 21 of the terminal apparatus 2 receives the output information output by the output unit 420 of the allocation-of-vehicle assisting apparatus 4. The processing unit 21 of the terminal apparatus 2 displays the output information received by the processing unit 21, on the display unit 23.

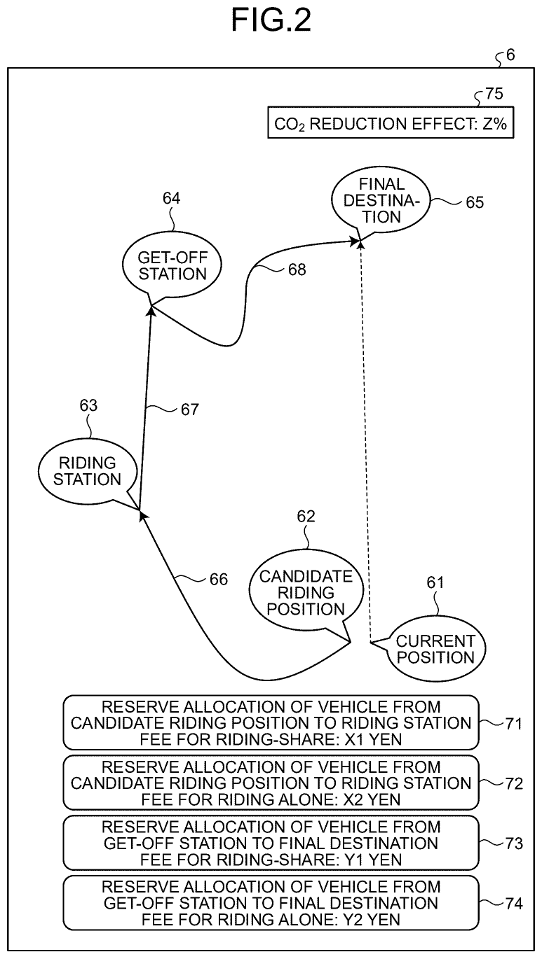

Here, the output information to be displayed by the terminal apparatus 2 will be described using FIG. 2. FIG. 2 is a schematic diagram illustrating an example of output information according to an embodiment. To specifically explain output information 6, a train is used as an example of a public transportation in FIG. 2. In the output information 6 illustrated in FIG. 2, a current position 61 of the user that corresponds to the current-position information, a candidate riding position 62 corresponding to the candidate riding-position information, a position 63 of a riding station that corresponds to the destination information, a position 64 of a get-off station that corresponds to the candidate riding-position information, and a position 65 of a final destination that corresponds to the destination information are indicated.

Further, in the output information 6 illustrated in FIG. 2, a travelling route 66 from the candidate riding position 62 to the riding station that corresponds to the travelling route information, a travelling route 67 from the riding station to the get-off station, and a travelling route 68 from the get-off station to the final destination are indicated. Moreover, in the output information 6 illustrated in FIG. 2, an allocation 71 of a vehicle of the travelling route 66 for riding-share, an allocation 72 of a vehicle of the travelling route 66 for riding alone, an allocation 73 of a vehicle of the travelling route 68 for riding-share, and an allocation 74 of a vehicle of the travelling route 68 for riding alone, which correspond to the booking information, and reduction effect information 75 are indicated. Further, the allocations 71 to 74 of the vehicle each include usage-fee information about usage of the ride-hailing service.

For example, when one of the allocations 71 to 74 of the vehicle illustrated in FIG. 2 is pressed by the user on the terminal apparatus 2, the operation unit 24 of the terminal apparatus 2 receives the operation performed by the user. Then, based on the operation received by the operation unit 24, the processing unit 21 of the terminal apparatus 2 transmits booking instruction information corresponding to an allocation of the vehicle, to the allocation-of-vehicle assisting apparatus 4. The booking instruction information includes identifier information of the user, candidate riding-position information, destination information, route information, usage-fee information, and the like.

With this configuration, by checking the output information 6 displayed on the terminal apparatus 2, the user can check a destination position and a usage-fee of the allocation-of-vehicle assisting service and book an allocation of a vehicle without inputting a destination position by the user itself. Further, by the reduction effect information 75 being included in the output information 6, the user can check, by comparing in travelling from the current position to the final goal position a first means of transportation that uses a user's vehicle only to a second means of transportation that uses the vehicle 3 and the public transportation, an effect of reduction of carbon dioxide that leads to decarbonization when the second means of transportation is selected as compared to the first means of transportation. Accordingly, the user improves the convenience of users as compared with the prior art.

Referring back to FIG. 1, the receiving unit 411 receives the booking instruction information from the terminal apparatus 2. The receiving unit 411 stores the received booking instruction information into the storage unit 42. When a booking instruction corresponding to the booking information is received, the transmitting unit 421 transmits allocation-of-vehicle information indicating an allocation of the vehicle 3, to the candidate riding position indicated by the candidate riding-position information. Specifically, based on the booking instruction information received by the receiving unit 411, the transmitting unit 421 transmits, to the vehicle 3, allocation-of-vehicle information indicating an allocation of the vehicle 3 driving from a candidate riding position included in the candidate riding-position information, to a destination of the user that is included in the destination information, for the user included in the identifier information. The transmitting unit 421 stores the transmitted allocation-of-vehicle information into the storage unit 42.

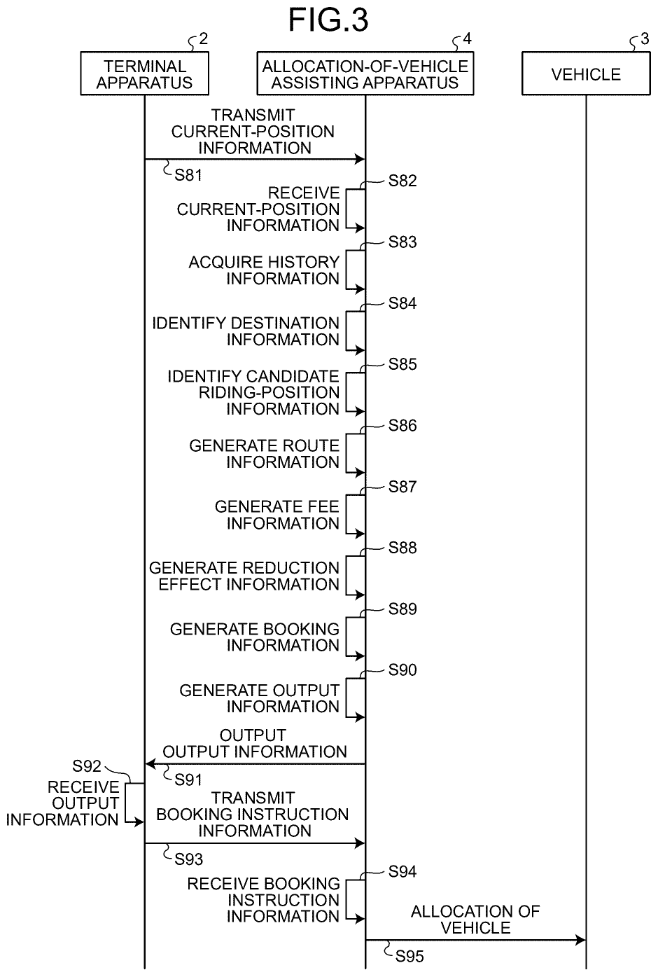

FIG. 3 is a sequence diagram illustrating an example of a flow of processing of the allocation-of-vehicle assisting system 1 according to an embodiment. The processing illustrated in FIG. 3 is assumed to be started after the position acquiring unit 22 of the terminal apparatus 2 has acquired current-position information indicating a current position of a user, when the user uses an allocation-of-vehicle assisting service provided by the terminal apparatus 2.

In Step S81, the processing unit 21 of the terminal apparatus 2 transmits the current-position information acquired by the position acquiring unit 22, to the terminal apparatus 2.

In Step S82, the receiving unit 411 of the allocation-of-vehicle assisting apparatus 4 receives the current-position information indicating the current position of the user that is transmitted by the terminal apparatus 2. In Step S83, the acquiring unit 412 of the allocation-of-vehicle assisting apparatus 4 identifies a user based on identifier information included in the current-position information received by the receiving unit 411, and acquires history information indicating a history of previous usage of the vehicle 3 by the identified user, from the storage unit 42.

In Step S84, the first identifying unit 413 of the allocation-of-vehicle assisting apparatus 4 identifies destination information indicating a destination of the user, based on the current-position information of the user that has been received by the receiving unit 411, and the history information acquired by the acquiring unit 412. In Step S85, the second identifying unit 414 of the allocation-of-vehicle assisting apparatus 4 identifies candidate riding-position information indicating a candidate position where the user rides the vehicle, using latitude-longitude information indicating a position of a destination of the user that is included in the destination information identified by the first identifying unit 413.

In Step S86, the first generation unit 415 of the allocation-of-vehicle assisting apparatus 4 generates route information indicating a route from a candidate riding position to a destination, using a latitude and a longitude of a candidate position where the user rides the vehicle that is included in the candidate riding-position information identified by the second identifying unit 414, and a latitude and a longitude of a destination of the user that is included in the destination information identified by the first identifying unit 413. In Step S87, the second generation unit 416 of the allocation-of-vehicle assisting apparatus 4 generates fee information about usage of the vehicle 3 based on the route information generated by the first generation unit 415.

In Step S88, the third generation unit 417 of the allocation-of-vehicle assisting apparatus 4 generates reduction effect information that indicates, by comparing in travelling from the current position to the final goal position a first means of transportation that uses a user's vehicle only to a second means of transportation that uses the vehicle 3 and the public transportation, an effect of reduction of carbon dioxide that leads to decarbonization when the second means of transportation is selected as compared to the first means of transportation. In Step S89, the fourth generation unit 418 of the allocation-of-vehicle assisting apparatus 4 generates booking information for booking an allocation of the vehicle 3 driving from the candidate riding position to the destination, using a latitude and a longitude of a candidate position where the user rides the vehicle that is included in the candidate riding-position information identified by the second identifying unit 414, and a latitude and a longitude of a destination of the user that is included in the destination information identified by the first identifying unit 413.

In Step S90, the fifth generation unit 419 of the allocation-of-vehicle assisting apparatus 4 generates output information including the destination information identified by the first identifying unit 413, the candidate riding-position information identified by the second identifying unit 414, and the booking information for booking an allocation of the vehicle 3 driving from the candidate riding position to the destination that has been generated by the fourth generation unit 418. In Step S9, the output unit 420 of the allocation-of-vehicle assisting apparatus 4 outputs the output information generated by the fifth generation unit 419.

In Step S92, the processing unit 21 of the terminal apparatus 2 receives the output information output by the output unit 420 of the allocation-of-vehicle assisting apparatus 4. The processing unit 21 of the terminal apparatus 2 displays the output information received by the processing unit 21, on the display unit 23. In Step S93, based on an operation received by the operation unit 24, the processing unit 21 of the terminal apparatus 2 transmits booking instruction information corresponding to an allocation of the vehicle, to the allocation-of-vehicle assisting apparatus 4.

In Step S94, the receiving unit 411 of the allocation-of-vehicle assisting apparatus 4 receives the booking instruction information from the terminal apparatus 2. In Step S95, based on the booking instruction information received by the receiving unit 411, the transmitting unit 421 of the allocation-of-vehicle assisting apparatus 4 transmits, to the vehicle 3, allocation-of-vehicle information indicating an allocation of the vehicle 3 driving from a candidate riding position included in the candidate riding-position information, to a destination of the user that is included in the destination information, for the user included in the identifier information.

As described above, the allocation-of-vehicle assisting apparatus 4 according to the present embodiment is an allocation-of-vehicle assisting apparatus 4 for allocating a vehicle to a user, and identifies destination information indicating a destination of the user based on current-position information indicating a current position of the user and history information indicating a history of previous usage of the vehicle 3 by the user, identifies, using the destination information, candidate riding-position information indicating a candidate position where the user rides the vehicle, and outputs output information including the destination information, the candidate riding-position information, and booking information for booking an allocation of the vehicle 3 driving from the candidate riding position to the destination.

With this configuration, by checking the output information 6 displayed on the terminal apparatus 2, the user can check a destination position and a usage-fee of the allocation-of-vehicle assisting service and book an allocation of a vehicle without inputting a destination position by the user itself. Accordingly, the user improves the convenience of users as compared with the prior art. Accordingly, according to the present embodiment, it is possible to improve the convenience of users as compared with the prior art when using the ride-hailing service.

Heretofore, an embodiment of the present disclosure has been described, but the embodiment has been presented by way of example, and is not intended to limit the scope of the invention. The embodiments can be implemented in other various forms, and various omissions, replacements, and changes can be made without departing from the gist of the invention. The embodiment is included in the scope and gist of the invention, and is similarly included in the scope of the invention described in the appended claims and an equivalent thereof.

Further, an effect in the embodiment described in this specification is a merely an example, and is not limited, and another effect may be caused. Hereinafter, modified examples will be described.

### First Modified Example

For example, a position of a public transportation that is to be identified by the first identifying unit 413 may be identified according to a predetermined order of priority. Specifically, the first identifying unit 413 identifies the position of the public transportation according to a predetermined order of priority. The order of priority sets a first nearest stop near the current position of the user as highest, a second nearest stop near a position included in the history information where the user got down the vehicle 3 as second highest, and a third nearest stop from which the user reaches the final goal position early as third highest. For example, the storage unit 42 stores order-of-priority information indicating the order of priority. Further, the order of priority is updated each time the user uses the allocation-of-vehicle assisting service.

### Second Modified Example

For example, when a position of a public transportation that is unavailable is identified as the destination, the allocation-of-vehicle assisting apparatus 4 may identify a position of an available public transportation as the destination. The case where a position of a public transportation that is unavailable is identified as the destination is a case where the public transportation stops due to an accident, or a riding regulation occurs due to delay, for example. Further, a timing at which the allocation-of-vehicle assisting apparatus 4 changes (identifies) a destination is a point of outputting the output information. In other words, when a position of a public transportation that is unavailable at a point of outputting the output information is identified as the destination, the first identifying unit 413 of the allocation-of-vehicle assisting apparatus 4 may identify a position of an available public transportation as the destination.

### Third Modified Example

For example, when a position of a public transportation that is unavailable is identified as the destination, the allocation-of-vehicle assisting apparatus 4 may generate route information indicating a route from the current position to the final goal position based on the history information, and output the output information and the route information. The case where a position of a public transportation that is unavailable is identified as the destination is a case where the public transportation stops due to an accident, or a riding regulation occurs due to delay, for example.

The first identifying unit 413 of the allocation-of-vehicle assisting apparatus 4 currently travels based on the history information in order to move the user to the final destination, and identifies a position of an available public transportation as the destination. Further, the second identifying unit 414 of the allocation-of-vehicle assisting apparatus 4 identifies candidate riding-position information indicating a candidate position where the user rides the vehicle, using latitude-longitude information indicating a position of a destination of the user that is included in the destination information identified by the first identifying unit 413.

Moreover, the first generation unit 415 generates route information indicating a route from a candidate riding position to a destination, using a latitude and a longitude of a candidate position where the user rides the vehicle that is included in the candidate riding-position information identified by the second identifying unit 414, and a latitude and a longitude of a destination of the user that is included in the destination information identified by the first identifying unit 413. Then, the output unit 420 of the allocation-of-vehicle assisting apparatus 4 outputs new route information generated by the first generation unit 415, together with the output information.

### Fourth Modified Example

For example, a destination to be identified by the first identifying unit 413 may change according to a time zone when the output information is output. This is because a destination included in the history information is sometimes unavailable depending on a regular holiday of a store or operating hours of a store, for example, since a destination of the user changes according to a time zone. Accordingly, a destination to be identified by the first identifying unit 413 may change according to a time zone when the output information is output.

### Fifth Modified Example

For example, the first identifying unit 413 of the allocation-of-vehicle assisting apparatus 4 sometimes identifies two or more destinations of a user. When two or more destinations of a user are identified, the first identifying unit 413 of the allocation-of-vehicle assisting apparatus 4 may identify one destination of the two or more destinations using at least one of the history information or the time zone.

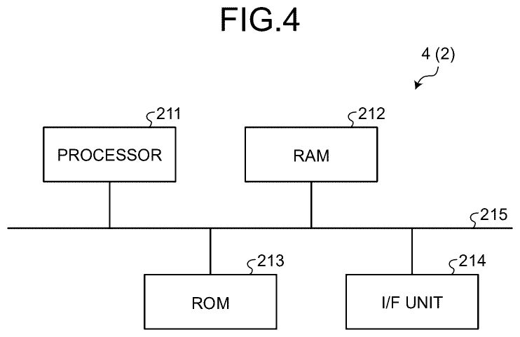

Next, a hardware configuration of the allocation-of-vehicle assisting apparatus 4 of the present embodiment will be described. FIG. 4 is a block diagram illustrating an example of a hardware configuration of the allocation-of-vehicle assisting apparatus 4. In addition, because an example of a hardware configuration of the allocation-of-vehicle assisting apparatus 4 that is illustrated in FIG. 4 can be applied also to the terminal apparatus 2, the detailed description of a hardware configuration of the terminal apparatus 2 will be omitted.

The allocation-of-vehicle assisting apparatus 4 has a hardware configuration that uses a normal computer, in which a central processing unit (CPU) 211, a random access memory (RAM) 212, a read only memory (ROM) 213, an I/F 214 for connecting to various device, and the like are connected to each other via a bus 215.

The CPU 211 is an arithmetic device that controls processing of the entire allocation-of-vehicle assisting apparatus 4. The RAM 212 stores data necessary for various types of processing to be executed by the CPU 211. The ROM 213 stores programs and the like that implement various types of processing to be executed by the CPU 211. The I/F 214 is an interface for connecting to an external apparatus or an external terminal via a communication line or the like, and performing data transmission and reception with the connected external apparatus or the external terminal.

Programs for executing the above-described various types of processing to be executed on the allocation-of-vehicle assisting apparatus 4 are provided with being pre-installed on the ROM 213 or the like. A program for executing a vehicle control method to be executed in the present embodiment may be provided with being recorded in a computer-readable recording medium such as a CD-ROM, a flexible disk (FD), a CD-R, or a digital versatile disc (DVD) as a file in a format installable onto these devices or an executable format.

Further, a program for executing an allocation-of-vehicle assisting method to be executed in the present embodiment may be stored onto a computer connected to a network such as the internet, and provided by being downloaded via the network. Further, a program for executing an allocation-of-vehicle assisting method to be executed in the present embodiment may be provided or delivered via a network such as the internet

The above-described embodiment can be arbitrarily combined with the above-described modified examples, and the above-described modified examples may be arbitrarily combined.

According to an allocation-of-vehicle assisting method, an allocation-of-vehicle assisting apparatus, a terminal apparatus, and an allocation-of-vehicle assisting system according to the present disclosure, it is possible to improve the convenience of users as compared with the prior art. In addition, the effects described herein are not necessarily limited, and may be any of the effects described in this specification.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An allocation-of-vehicle assisting method performed by an allocation-of-vehicle assisting apparatus for allocating a vehicle to a user, the allocation-of-vehicle assisting method comprising:
identifying destination information indicating a destination of the user based on current-position information indicating a current position of the user and history information indicating a history of previous usage of the vehicle by the user;
identifying, using the destination information, candidate riding-position information indicating a candidate position where the user rides the vehicle; and
outputting output information including the destination information, the candidate riding-position information, and booking information for booking an allocation of the vehicle driving from the candidate position to the destination.

2. The allocation-of-vehicle assisting method as claimed in claim 1, wherein
the destination includes a position of a public transportation that the user uses and a final goal position where a travel by the user ends, and
the identifying of the destination information includes
identifying the final goal position as the destination when the current position of the user overlaps with the position of the public transportation, and
identifying the position of the public transportation as the destination when the current position of the user does not overlap with the position of the public transportation.

3. The allocation-of-vehicle assisting method as claimed in claim 2, wherein
the position of the public transportation is identified according to a predetermined order of priority, and
the order of priority sets a first nearest stop near the current position of the user as highest, a second nearest stop near a position included in the history information where the user got down the vehicle as second highest, and a third nearest stop from which the user reaches the final goal position early as third highest.

4. The allocation-of-vehicle assisting method as claimed in claim 2, wherein the identifying of the destination information includes excluding, from the destination, a current position of the user where the user stayed a predetermined time before from a current time.

5. The allocation-of-vehicle assisting method as claimed in claim 2, wherein the identifying of the destination information includes, when a position of a public transportation that is unavailable at a point of outputting the output information is identified as the destination, identifying a position of an available public transportation as the destination.

6. The allocation-of-vehicle assisting method as claimed in claim 2, wherein
the identifying of the destination information includes, when a position of a public transportation that is unavailable at a point of outputting the output information is identified as the destination, generating route information indicating a route from the current position to the final goal position based on the history information, and
the outputting includes outputting the output information and the route information.

7. The allocation-of-vehicle assisting method as claimed in claim 2, wherein the destination changes according to a time zone when the output information is output.

8. The allocation-of-vehicle assisting method as claimed in claim 7, wherein the identifying of the destination information includes, when the identified destination includes two or more destinations, identifying one of the two or more destinations using at least one of the history information or the time zone.

9. The allocation-of-vehicle assisting method as claimed in claim 1, wherein
the output information includes fee information about usage of the vehicle, and
the fee information includes first usage-fee information indicating a usage fee for the user riding alone and second usage-fee information indicating a usage fee for the user riding-share.

10. The allocation-of-vehicle assisting method as claimed in claim 2, wherein the output information includes reduction effect information that indicates, by comparing in travelling from the current position to the final goal position a first means of transportation that uses a user's vehicle only to a second means of transportation that uses the vehicle and the public transportation, an effect of reduction of carbon dioxide that leads to decarbonization when the second means of transportation is selected as compared to the first means of transportation.

11. The allocation-of-vehicle assisting method as claimed in claim 1, further comprising
allocating the vehicle to the candidate position indicated by the candidate riding-position information when receiving a booking instruction corresponding to the booking information.

12. An allocation-of-vehicle assisting apparatus for allocating a vehicle to a user, the apparatus comprising:
a memory; and
a processor coupled to the memory, and configured to:
identify destination information indicating a destination of the user based on current-position information indicating a current position of the user and history information indicating a history of previous usage of the vehicle by the user;
identify, using the destination information, candidate riding-position information indicating a candidate position where the user rides the vehicle; and
output output information including the destination information, the candidate riding-position information, and booking information for booking an allocation of the vehicle driving from the candidate position to the destination.

13. The allocation-of-vehicle assisting apparatus as claimed in claim 12, wherein
the destination includes a position of a public transportation that the user uses and a final goal position where a travel by the user ends, and
the processor is configured to:
identify the final goal position as the destination when the current position of the user overlaps with the position of the public transportation; and
identify the position of the public transportation as the destination when the current position of the user does not overlap with the position of the public transportation.

14. The allocation-of-vehicle assisting apparatus as claimed in claim 13, wherein
the position of the public transportation is identified according to a predetermined order of priority, and
the order of priority sets a first nearest stop near the current position of the user as highest, a second nearest stop near a position included in the history information where the user got down the vehicle as second highest, and a third nearest stop from which the user reaches the final goal position early as third highest.

15. The allocation-of-vehicle assisting apparatus as claimed in claim 13, wherein the processor is configured to exclude, from the destination, a current position of the user where the user stayed a predetermined time before from a current time.

16. The allocation-of-vehicle assisting apparatus as claimed in claim 13, wherein when a position of a public transportation that is unavailable at a point of outputting the output information is identified as the destination, the processor is configured to identify a position of an available public transportation as the destination.

17. The allocation-of-vehicle assisting apparatus as claimed in claim 13, wherein
when a position of a public transportation that is unavailable at a point of outputting the output information is identified as the destination, the processor is configured to generate route information indicating a route from the current position to the final goal position based on the history information, and
the processor is configured to output the output information and the route information.

18. The allocation-of-vehicle assisting apparatus as claimed in claim 13, wherein the destination changes according to a time zone when the output information is output.

19. A terminal apparatus comprising:
a memory; and
a processor coupled to the memory and configured to:
acquire current-position information indicating a current position of a user; and
display output information including destination information indicating a destination of the user identified based on the current-position information and history information indicating a history of previous usage of the vehicle by the user, candidate riding-position information indicating a candidate position where the user rides the vehicle identified by using the destination information, and booking information for booking an allocation of the vehicle driving from the candidate position to the destination.

20. An allocation-of-vehicle assisting system comprising:
the allocation-of-vehicle assisting apparatus as claimed in claim 12; and
a terminal apparatus, wherein
the terminal apparatus includes:
a memory; and
a processor coupled to the memory and configured to:
acquire current-position information indicating a current position of the user; and
display the output information.
